(19) United States
(12) Patent Application Publication
(10) Pub. No.: US 2025/0225447 A1
(43) Pub. Date: Jul. 10, 2025

(54) BIDDING AND BOOKING SYSTEM AND METHOD FOR ON DEMAND AIR TRAVEL

(71) Applicant: Joseph Carello, Deltona, FL (US)

(72) Inventor: Joseph Carello, Deltona, FL (US)

(21) Appl. No.: 19/011,276

(22) Filed: Jan. 6, 2025

Related U.S. Application Data
(60) Provisional application No. 63/617,883, filed on Jan. 5, 2024.

(51) Int. Cl. G06Q 10/02; G06Q 30/08

(52) U.S. Cl. CPC G06Q 10/02; G06Q 30/08

(57) ABSTRACT

A system and method for facilitating the booking of private charter flights, with a focus on optimizing empty leg utilization. The system integrates with operators' scheduling software via APIs to automate the listing of empty leg flights and provide real-time updates. Passengers can search, bid on, and book flights directly through intuitive mobile and web interfaces. The platform features an auction-based bidding mechanism, enabling transparent competition among operators and efficient price discovery for passengers. Additionally, passengers can request custom itineraries, which operators can bid on in real time. Secure transactions are facilitated through an escrow system, ensuring confidence for both parties. By automating processes and fostering competition, the invention reduces inefficiencies, enhances transparency, and minimizes the environmental impact of empty repositioning flights.

### CROSS-REFERENCE TO RELATED APPLICATIONS

This application claims priority under 35 U.S.C. § 119(e) to U.S. Provisional Patent Application Ser. No. 63/617,883, filed Jan. 5, 2024, and entitled “BIDDING AND BOOKING SYSTEM AND METHOD FOR ON DEMAND AIR TRAVEL,” which is hereby incorporated by reference in its entirety.

### FIELD OF THE INVENTION

The present invention relates broadly to flight booking software and methods. More particularly, the present invention relates to a decentralized booking of on-demand flight services through use of portable computing devices.

### BACKGROUND

Charter aircraft often fly empty on repositioning flights between passenger drop off and pick up locations. These empty flight legs are inefficient and costly for operators and represent wasted opportunity to transport passengers or cargo. Currently, there is no transparent marketplace allowing operators to easily list and sell empty legs to prospective passengers.

Existing private jet booking platforms rely on human brokers as middlemen between passengers and operators. This adds inefficiency, opacity, and cost. No platform allows passengers to transparently solicit competitive bids from multiple operators and make bookings directly without broker involvement.

### SUMMARY OF THE INVENTION

The proposed system revolutionizes aircraft booking by enabling operators to automatically list empty flight legs for sale directly to passengers through mobile and web interfaces. This integration with operators' scheduling systems facilitates the posting of empty legs without manual input. Additionally, the system features an auction-style bidding process, allowing prospective passengers to bid on these empty legs. To ensure the security of both parties, transactions are handled through escrow.

Furthermore, prospective passengers can request trip quotes by entering their desired itinerary details into the system. This feature opens the door for operators to view and compete for these requests, fostering a transparent and competitive bidding environment. Passengers then have the option to select and confirm the most suitable bid.

A key aspect of this system is its backend integration with operators' scheduling and operations software via API. This enables automated listings of empty legs and the processing of passenger-solicited trip quotes. The system operates on a fee- based model, generating commissions from trip bookings.

This new approach offers several advantages over existing platforms. It eliminates the need for broker middlemen, allowing for direct bookings. The process of soliciting quotes from operators becomes transparent and competitive. Moreover, the extensive use of API integration streamlines the listing and quoting process, making it largely automated. This not only opens up new revenue streams by filling empty legs but also significantly reduces costs and emissions associated with repositioning flights.

The invention disclosed herein provides a computer-implemented method for providing transport services, the method being performed by one or more processors. The method includes the steps of receiving a search from a user's client device, initiating an empty leg auction, sending said empty leg auction to an operator's client device, and completing a trip request.

It is an object of the present invention to provide a system that enables transparent and efficient booking of private charter flights by automating the listing, bidding, and booking processes through a user-friendly interface.

It is yet another object of the present invention to provide a platform that integrates seamlessly with operators' scheduling systems via API, allowing real-time updates and automated management of empty leg flight listings.

It is a further object to provide a method that fosters competition among operators by enabling passengers to solicit and compare bids for customized itineraries or empty leg flights, thereby promoting cost efficiency and transparency.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a flow chart of the method steps of the disclosed embodiment of a bidding and booking system and method for on demand air travel.

FIG. 2 illustrates a network diagram with user and operator devices.

### DETAILED DESCRIPTION OF THE INVENTION

The invention herein involves a software application that solves inefficiencies in the charter aircraft market by providing an automated marketplace platform connecting aircraft operators and prospective passengers. Many charter aircraft flights involve empty repositioning legs between passenger drop off and pick up points. Operators fly these empty legs at high cost with no revenue.

The invention herein integrates with operators' scheduling systems via API to automatically post empty legs for direct sale without a broker intermediary. The app provides web and mobile interfaces allowing passengers to view empty leg listings and bid in a transparent, auction-style system to book seats. Transactions are handled through escrow, protecting both parties.

In addition to reducing waste from empty flights and providing operators new revenue streams, the invention herein facilitates the traditional charter booking process. Passengers can enter details for a requested one-way or round-trip itinerary and solicit quotes from all relevant aircraft operators in a region. Quoted pricing is visible to both passengers and competing operator companies, encouraging price competition in real time. Passengers can review quotes and transparently select and confirm the best option from participating operators.

The dual empty leg listing and competitive quote solicitation systems make the invention herein a uniquely efficient charter booking platform. Automation via operator API integration combined with the app's role as neutral intermediary reduces overhead costs associated with human brokers. This efficiency allows the invention herein to operate on a sustainable fee-based model, collecting commissions on trip bookings. With transparency, competition, and reduced waste in repositioning flights, the invention herein provides value to both operators and passengers.

The aviation industry, particularly the private charter segment, faces persistent inefficiencies related to empty repositioning flights, known as “empty legs.” These flights, which occur when a charter aircraft moves between passenger drop-off and pick-up locations without carrying paying passengers or cargo, represent significant cost burdens for operators. They also contribute to wasted fuel, increased emissions, and lost revenue opportunities. Despite technological advances in flight scheduling and online marketplaces, a cohesive solution that directly connects passengers and operators while addressing these inefficiencies has not yet been realized.

Traditionally, charter flight bookings are broker-mediated. Brokers serve as intermediaries between passengers seeking flights and operators managing aircraft, often adding layers of complexity, increased costs, and a lack of transparency. Passengers are left with limited visibility into pricing and availability, while operators struggle to efficiently fill empty legs or respond to dynamic demand. Existing platforms rely heavily on manual processes and human intervention, resulting in slower transaction times and reduced competitiveness.

The present invention transforms the charter booking landscape by introducing a decentralized, automated system for on-demand air travel. By integrating advanced software applications with operators' scheduling systems via application programming interfaces (APIs), this invention creates a transparent, competitive marketplace that eliminates the need for human brokers. Passengers gain access to a seamless platform where they can view, bid on, and book empty leg flights directly from operators. Operators, in turn, can list their available empty legs or respond to passenger-requested itineraries through a streamlined interface, maximizing aircraft utilization and minimizing operational inefficiencies.

This system is not merely a booking tool but a comprehensive solution to modernize the private aviation industry. It incorporates auction-style bidding mechanisms, real-time quote generation, and escrow-based transaction processing. These features ensure equitable pricing, foster competition, and enhance the security of both passenger and operator transactions. The platform operates across mobile and web interfaces, allowing for intuitive user experiences regardless of device.

By leveraging API integrations, the system achieves a high degree of automation, reducing manual input from operators and passengers alike. Operators can automate the listing of empty legs, while passengers can solicit and receive competitive bids for their requested itineraries. This dual functionality ensures a dynamic marketplace that benefits both parties while addressing the industry's longstanding inefficiencies.

The implications of this invention extend beyond revenue generation for operators. The automated marketplace reduces the environmental impact of repositioning flights by filling empty legs with passengers or cargo. Furthermore, the platform democratizes access to private air travel by increasing transparency and competitiveness, making charter services more accessible to a broader demographic of passengers.

The present invention delivers a groundbreaking approach to addressing inefficiencies in private aviation. By creating a transparent, automated, and competitive marketplace for on-demand air travel, the system aligns economic incentives with environmental benefits and consumer convenience. It represents a significant advancement in the field of flight booking technologies and serves as a model for efficiency and innovation in the private aviation sector.

The invention described herein addresses inefficiencies in the private aviation industry by introducing a software platform that automates and optimizes the booking process for charter flights, particularly focusing on the costly issue of empty leg flights. Empty legs occur when a charter aircraft flies without passengers during repositioning trips between destinations. These flights represent significant lost revenue opportunities for operators while simultaneously contributing to unnecessary fuel consumption and emissions. By offering an innovative marketplace, the invention seeks to fill these empty legs with paying passengers, transforming a traditionally wasteful process into a profitable and efficient operation.

Central to this invention is the seamless integration of operators' scheduling and operations systems with the platform via application programming interfaces (APIs). This integration allows empty leg flights to be automatically listed for sale on the platform without requiring manual input from operators. Once an empty leg is available, it is visible to prospective passengers through an intuitive mobile or web-based interface. This automation not only reduces operational burdens on operators but also accelerates the time it takes to list flights, ensuring the platform reflects real-time availability.

The platform introduces auction-style bidding to the charter flight booking process, enabling prospective passengers to place competitive bids for empty leg flights. Operators can set minimum reserve prices for their flights, and passengers can bid above these thresholds until the auction concludes. This transparent, competitive process ensures that pricing reflects market demand, benefiting both passengers and operators. For added security, the platform uses an escrow-based payment system to safeguard transactions and instill confidence in both parties.

In addition to listing empty legs, the platform also enables passengers to request custom itineraries by entering details such as departure and destination airports, dates, and passenger requirements. These trip requests are then shared with all relevant operators in the region, who can respond with competitive quotes. Passengers can review these quotes, compare prices and options, and select the one that best suits their needs. By facilitating direct interaction between passengers and operators, the system eliminates the need for brokers, reducing costs and improving transparency in the booking process.

From a user experience perspective, the platform offers a range of features to streamline the search and booking process. Passengers can filter search results by parameters such as departure date, aircraft type, cabin size, and in-flight service options. The platform's mobile and web applications are designed to provide a seamless and intuitive interface, ensuring that users can easily navigate the system, place bids, and finalize bookings. Notifications, user watchlists, and bid history tracking further enhance the user experience by making it easy to manage ongoing and upcoming transactions.

On the operator side, the system provides tools to manage auctions and respond to passenger requests. Operators can modify their listings by extending auction deadlines or adjusting minimum reserve prices based on evolving demand. They can also review passenger trip requests, submit bids, and track the status of their listings through the platform's interface. These tools are designed to give operators flexibility while maximizing their ability to fill empty legs and compete effectively in the marketplace.

The platform's business model is designed to be both sustainable and scalable. It operates on a commission-based structure, collecting fees from successful bookings. This model aligns the platform's interests with those of its users, as it incentivizes the platform to facilitate transactions and generate value for both passengers and operators. Additionally, by focusing on automating the booking process and minimizing manual intervention, the platform achieves significant cost savings that can be passed on to users.

Beyond its economic impact, the invention has meaningful environmental benefits. By filling empty leg flights with passengers or cargo, the platform reduces the number of unnecessary flights, leading to lower fuel consumption and emissions. This aligns with broader industry goals of improving sustainability and reducing the carbon footprint of private aviation. The invention thus contributes to both economic efficiency and environmental responsibility.

This new approach represents a significant departure from traditional charter flight booking methods, which often rely on human brokers and opaque pricing models. By offering a transparent and automated marketplace, the invention democratizes access to private aviation services, making them more accessible to a broader range of passengers. It also fosters competition among operators, driving innovation and improving the overall quality of service in the industry.

The invention enhances the private charter flight market by addressing longstanding inefficiencies and creating a transparent, competitive, and environmentally sustainable solution. Through its combination of API integration, auction-style bidding, and user-friendly interfaces, the platform delivers value to both operators and passengers while setting a new standard for efficiency and innovation in private aviation.

The following discloses a summary of screens and functionalities of the current invention.

Home Screen: The home screen provides users with an intuitive interface to begin their journey. Key elements include fields for entering the origin and destination, quick access to search features, and a list of departing soon charter flight auctions. Navigation options allow users to explore additional features such as their profile, transfers, and settings.

Search Empty Legs Screen: This screen enables users to search for empty leg flights by inputting their desired origin, departure date, and optional filters such as cabin size, jet make, and operator preferences. Users can toggle between searching for empty leg flights and requesting custom trips. Search results are displayed in order of departure date and proximity to the user.

Empty Leg Auction Screen: The auction screen provides details about specific empty leg flights, including aircraft images, departure and arrival locations, auction countdown timers, and flight details like departure time and cabin size. Users can view bid history, agree to terms and conditions, and place bids directly from this screen. Additional features include adding auctions to a watchlist and viewing service descriptions.

Request Trip Screen: This screen allows users to request custom trips by specifying itinerary details such as origin, destination, dates, and passenger requirements. Flexible date options can be selected for a broader range of results. Users can view operator responses in the form of bids and select the best option for their trip.

Requested Trip Screen: Once a trip request is submitted, users can view responses from operators in this screen. Features include a visual map of the flight route, a list of reverse bids submitted by operators, and tools for comparing and selecting bids. Users can finalize their trip by agreeing to terms and selecting the “Buy Now” option.

Profile Screen: The profile screen displays the user's avatar, contact information (e.g., name, phone number, email), account balance, and account type (user, operator, or admin). Users can add funds to their account, edit their profile, toggle dark mode, view notifications, and access a watchlist of monitored auctions.

Transfers Screen: This screen provides users with a comprehensive view of their financial transactions within the platform. Users can add funds via credit card, bank transfer, or apply for a line of credit. The screen also tracks payment history, including flights paid for or refunded.

Documents Screen: The documents screen facilitates compliance with identification requirements for passengers and associated travelers. Users can upload and manage valid forms of identification such as driver's licenses, passports, and visas if necessary for their destination.

Settings Screen: The settings screen offers options to configure general preferences, including enabling location services, managing terms and conditions, and adjusting other system-wide features.

Operator-Specific Screens: For operators, the platform provides tailored interfaces, including: a home screen listing relevant trip requests matching their fleet type or position; tools to manage empty leg auctions, such as extending auction deadlines or lowering reserve prices; a profile screen showcasing operator details (e.g., business address, fleet list, and operator ratings); a plurality of management screens for financial transfers and passenger-provided documentation.

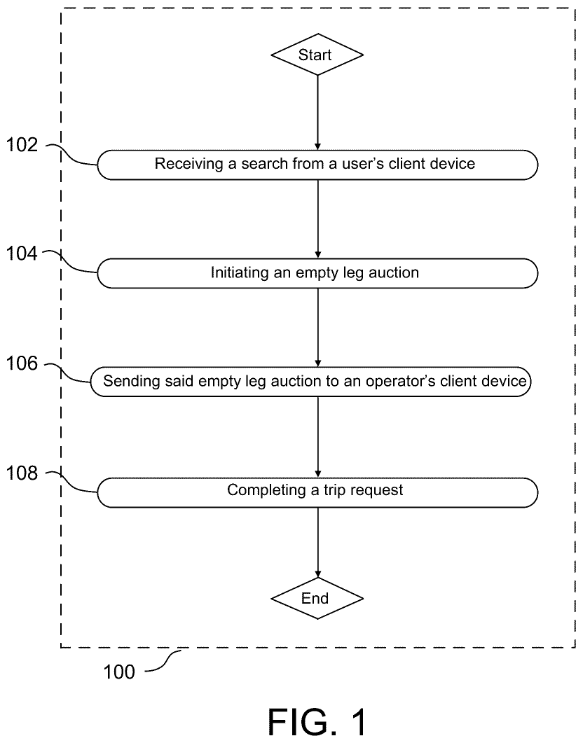

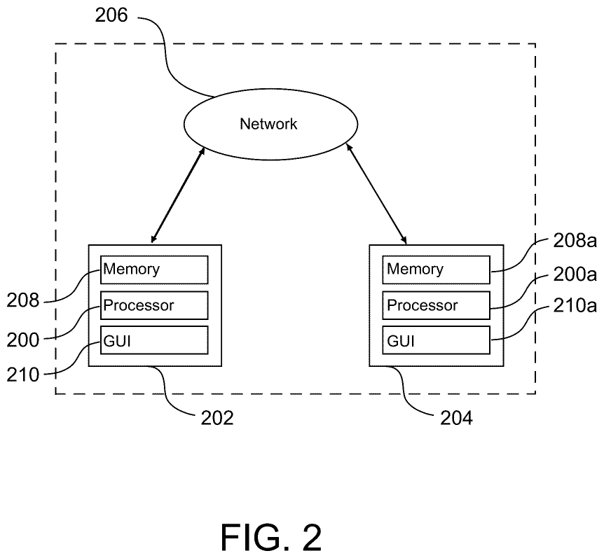

The bidding and booking system and method for on-demand air travel of the present invention may be used to enable transparent and efficient booking of private charter flights, automate the listing and bidding processes, and facilitate secure trip confirmations between passengers and operators. This apparatus and system are particularly shown in FIGS. 1 and 2.

FIG. 1 illustrates a flow chart of the method steps of the disclosed embodiment. The method 100 includes the steps of receiving 102 a search from a user's client device 202, initiating 104 an empty leg auction, sending 106 said empty leg auction to an operator's client device 204, and completing 108 a trip request.

FIG. 2 illustrates a network diagram of the user's client device 202 with a processor 200, memory 208, and graphic user interface 210, an operator's client device 204 with a processor 200a, memory 208a, and graphic user interface 210a, and a network 206.

In an exemplary embodiment, a computer-implemented method 100 for providing transport services is disclosed. The method 100 is performed by one or more processors 200. The method 100 comprises receiving 102 a search from a user's client device 202, initiating 104 an empty leg auction, sending 106 said empty leg auction to an operator's client device 204, and completing 108 a trip request.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A computer-implemented method for providing transport services, the method being performed by one or more processors and comprising:
receiving a search from a user's client device;
initiating an empty leg auction;
sending said empty leg auction to an operator's client device; and
completing a trip request.
